(19) United States
(12) Patent Application Publication
(10) Pub. No.: US 2006/0065739 A1
(43) Pub. Date: Mar. 30, 2006

(54) Radio frequency detectable medical supplies

(76) Inventors: William Hallen Falls JR., Taipei (TW); Brian Terrence Mann, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/942,036

(22) Filed: Sep. 16, 2004

(51) Int. Cl. G06K 19/06; G08B 13/14

(52) U.S. Cl. 235/492; 340/572.8; 340/572.9

(57) ABSTRACT

A medical supply such as an operating room towel, laparotomy sponge, gauze pad, bandage, or swab with radio frequency detectable material which eliminates the need for re-entry into a patent after operating in situations where medical supplies are missing. The patent can be easily scanned with a handheld scanner to determine if the medical supply was accidentally left inside the patient. If no RF detectable material is observed, unnecessary re-entry into the patient is prevented. The radio frequency detectable material is incorporated into the medical supply as a tag, in the handle, as a handle, stitched to the medical supply, woven into the medical supply, or sewn into a seam in the medical supply. An identifier on the medical supply indicates that the medical supply is an RF detectable medical supply. In addition to preventing unnecessary re-entry, scanning for RF detectable material is much safer than scanning for x-ray detectable material.

### BACKGROUND OF THE INVENTION

1. Field of the Invention

The present invention relates to medical supplies. More specifically, the present invention discloses radio frequency detectable medical supplies such as operating towels, O.R. Towels, operating room towels, laparotomy sponges, and gauze pads, which eliminate the need for re-entry into a patient after operating, to search for missing supplies in situations where supplies are, or may be, missing.

2. Description of the Prior Art

Prior to operating, medical staff prepare the patient for surgery by placing towels on the patient around the area to be operated on. This area is commonly known as the incision area. These towels are positioned so that they overlap and surround the area where the opening will be. Additionally, the towels may be placed on trays, and surgical tools can then be laid out on the towels.

The main purpose of the towels is to establish a clean and sanitary working area during surgery, and to contain smaller amounts of spilled or splashed blood. However, during the operation or surgery, after the surgeon makes the incision, blood inevitably flows from the patient. Unfortunately, in some situations, the blood flow is substantial, and medical personnel often use the towels for other than their intended purposes.

When this occurs, there is the possibility that the towel is placed inside the body. Since the towel is drenched in blood, it may become difficult to identify the towel. In some instances, towels have been left inside the body of the patient. If the towels are not noticed as missing, they can remain in the patient for some time before causing enough discomfort that the patient seeks medical help. This results in the patient having to undergo another surgery to search the operation site for a missing towel, and remove the towel if found.

However, it is currently extremely difficult to determine if a towel was left inside the patient without re-entry into the patient. As a result, patients may undergo unnecessary surgery for other issues, when in reality the cause is a misplaced towel.

Furthermore, not only has the patient unnecessarily suffered, but also medical personnel are thus susceptible to malpractice lawsuits in these situations, which is extremely expensive.

Therefore, there is a need for an effective way of preventing unnecessary re-entry into a patient after surgery to determine whether medical supplies were left inside the patient, thereby eliminating unnecessary patient suffering and reducing the risk of malpractice lawsuits.

### SUMMARY OF THE INVENTION

To achieve these and other advantages and in order to overcome the disadvantages of the conventional method in accordance with the purpose of the invention as embodied and broadly described herein, the present invention provides an absorbent medical supply with radio frequency detectable material which eliminates the need for re-entry into a patent after operating in situations where medical supplies are missing or there is great patient distress following surgery and a missing object may be suspected.

Utilizing the medical supply of the present invention, the patient can easily be scanned by a scanner such as a handheld scanner to determine whether medical supplies have been left inside the patient after surgery. Upon scanning, the radio frequency (“RF”) detectable material can easily be observed by medical personnel if a medical supply is still inside the patient. If no RF detectable material is observed, unnecessary re-entry into the patient is prevented.

The medical supply of the present invention comprises towels, operating room OR towels, swabs, bandages, laparotomy sponges, gauze, gauze pads, gauze bandages, medical sponges, and medical bandages. Each of these types of medical supplies is utilized during surgery where the chance or risk is high of accidentally leaving a medical supply inside of a patient.

Laparotomy sponges or Lap sponges are typically used to absorb flowing blood or blood inside the body.

Towels are used to cover Gurneys or operating beds and also provide a sterile site to lay sterilized instruments and operation tools on. The towels provide a sterile splash covering to absorb spilt or splashed blood, while also marking out an incision site. They are not typically intended to soak up blood like gauze or a lap sponge.

The present invention provides a medical supply that comprises at least one piece of RF detectable material so that scanning will indicate the presence of a medical supply.

The present invention also provides a medical supply that comprises at least one piece of RF detectable material enclosed in a hem of the medical supply material, woven into, ironed onto, sewn into, adhered to, bonded to, or in anyway attached to the medical supply, making manufacturing convenient and ensuring the RF detectable material is not inadvertently separated from the medical supply.

The medical supply may be, for example, an operating room towel or OR towel, a laparotomy or lap sponge, a pad, gauze, sponge, swab, or bandage. The material of the medical supply can be comprised of gauze, cotton, synthetic, foam, sponge, or a combination of these materials.

The radio frequency detectable material is, for example, a radio frequency tag or a radio frequency identification tag. Additionally, the RF detectable material can be active or passive. Preferably, the radio frequency detectable material is not sensitive to orientation. In this way, the accuracy of reading is improved. If the RF detectable material comprises a memory, the memory can be read only, write once/read many, or write many/read many.

The radio frequency identification (RFID) tags comprise an antenna or a plurality of antennas that permit them to receive and respond to radio frequency queries from an RFID scanner or transceiver.

Passive RFID tags do not have their own power supply and are powered by the electrical current induced in the antenna by the incoming radio-frequency scan. This small amount of power is sufficient for the tag to send a response to the scanner. Since the passive tag does not have its own power supply, the size and cost are reduced.

Active RFID tags comprise a power source such as a battery. They also have longer ranges and larger memories for storing data than passive tags.

The typical operating frequencies of the RF tags are low frequency (about 100-500 KHz), high frequency (about 10-15 MHz), ultra high frequency (about 860-960 MHz), and microwave (about 2.45 GHz). However, the operating frequency can be selected according to requirements.

The RFID tag can comprise a unique code or identifier which allows individual tags to be identified. This code can comprise, for example, manufacturer data, hospital data, patient data, surgeon data, serial number, etc.

The RF detectable material is incorporated into the medical supply as a tag, stitched to the medical supply, sewn into a seam of the medical supply, incorporated in a handle of the medical supply, is the handle of the medical supply, or woven into the medical supply.

Furthermore, the medical supply may have an identifier that indicates the medical supply is an RF detectable medical supply. The identifier is a label, tag, marking, printing, number, letter, shape, code, thread, or color. Typically, the identifier is visible but is not required to be. For example, the thread used in stitching can be a color to identify the RF detectable medical supply. Alternatively, the color of the medical supply can be colored or marked in such a way as to identify the medical supply as an RF detectable medical supply.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1A-D are drawings illustrating hemmed medical supplies with radio frequency detectable material according to embodiments of the present invention; and

FIGS. 2A-C are drawings illustrating medical supplies with radio frequency detectable material according to embodiments of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

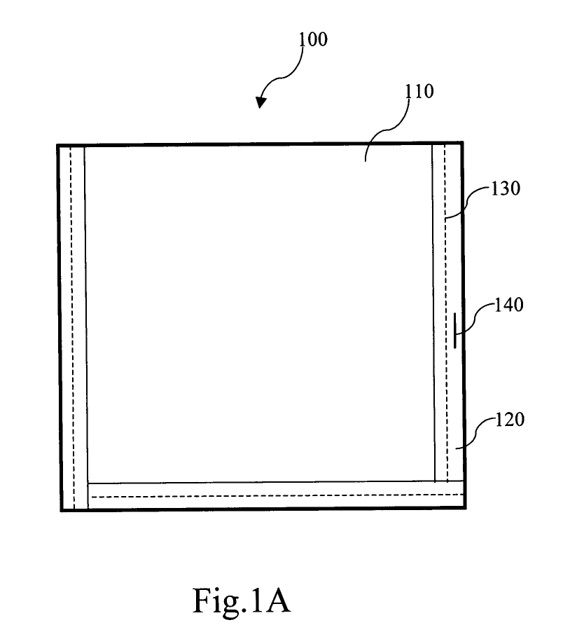

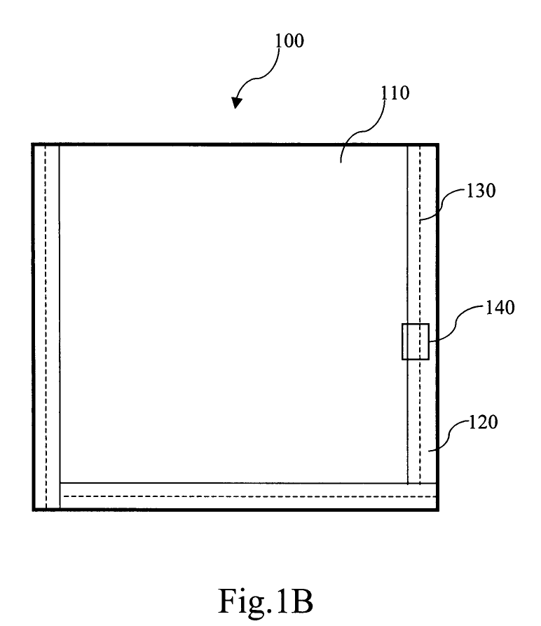

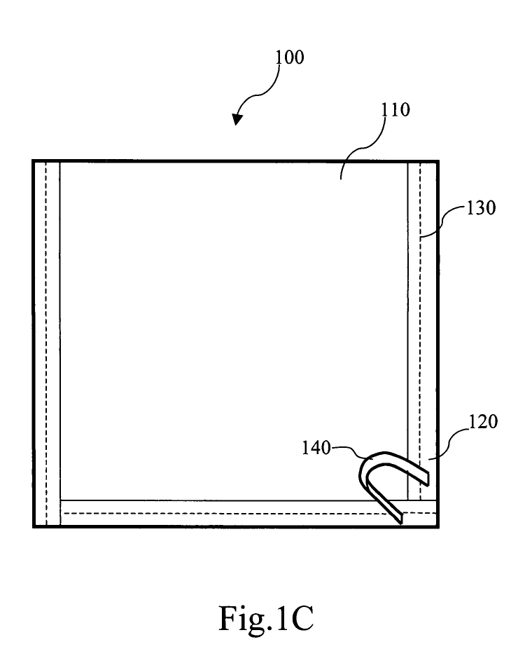

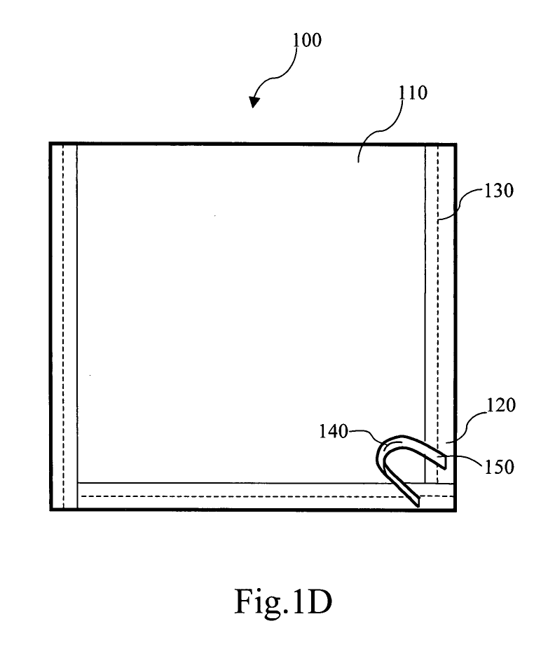

Refer to FIG. 1A, which is a drawing illustrating a hemmed medical supply with radio frequency detectable material according to an embodiment of the present invention.

As shown in FIG. 1A, the RF detectable medical supply 100 of the present invention comprises a medical supply 110, for example, an OR towel, lap sponge, swab, bandage, or pad. The material of the medical supply can comprise gauze, cotton, synthetic, foam, sponge, or a combination of these materials. The material can be single-ply or multi-ply and be dyed, or undyed and colored as desired.

In FIG. 1A, the medical supply 110 has at least one edge of the medical supply 110 folded over and stitched to create a hem 120. In an embodiment of the present invention, three sides of the medical supply 110 are hemmed; however, one, two, three, or all four sides of the medical supply 110 can be hemmed or un-hemmed.

The thread 130 used for stitching the hem 120 is for example, a synthetic thread. The color of the thread 130 can be the same color as the medical supply 110. However, to add further advantages, the color of the thread 130 can be a different color than the color of the medical supply 110. This allows the medical supply 110 to be easily identified as being RF detectable.

Prior to stitching or during stitching, a piece of RF detectable material 140, for example an RFID tag, is placed inside the fold in the fabric in order to be enclosed in the hem 120. The RF detectable material 140 is a piece of material that is easily detectable upon scanning. In embodiments of the present invention the RF detectable material 140 is an RF tag, an RFID tag, or other material that can be detected by RF scanning.

The length, size, attributes, capabilities, or amount of RF material 140 is selectable depending on cost, effectiveness, or convenience.

Refer to FIG. 1B, which is a drawing illustrating a hemmed medical supply with radio frequency detectable material according to an embodiment of the present invention.

Alternatively, the RF detectable material 140 is a piece that is sewn inside the hem 120 or through which the hem stitching 130 is sewn. Exposing a portion of the RF detectable material 140 allows it to be seen without further identifying marks. Stitching through the material 140 provides further adhesion of the RF detectable material 140 to the medical supply 110.

Refer to FIG. 1C, which is a drawing illustrating a hemmed medical supply with radio frequency detectable material according to an embodiment of the present invention.

In another embodiment the RF detectable material 140 is attached to the medical supply 110 in the form of a loop. The thread 130 used to stitch the hem 120 attaches the RF detectable material 140 to the medical supply 110. This has the advantage of providing a means of hanging or grasping the medical supply 110, which adds to the convenience of the medical supply.

Refer to FIG. 1D, which is a drawing illustrating a hemmed medical supply with radio frequency detectable material according to an embodiment of the present invention.

In another embodiment of the present invention, the RF detectable material 140 is added to a loop 150 attached to the medical supply 110. The RF detectable material 140 can be enclosed in, sewn to, attached to, or adhered to the loop 150. This allows the RF detectable material 140 to be attached to the medical supply 110 at any time.

The RF detectable material can be shaped, coded, numbered, or have identifying characteristics. In situations where other RF detectable objects are intentionally placed inside a patient, the unique characteristics of the RF detectable material easily identifies the medical supply of the present invention. For example, the material can have wording or coding such as a serial number that can be read upon scanning.

Furthermore, multiple pieces of the RF detectable material can be used to increase identification or detection. For example, a piece of RF detectable material can be placed in several hems or locations of the medical supply.

Additionally, the material can be a label or inside a label attached to the medical supply. For example, a label with the manufacturer or brand name of the medical supply can comprise RF detectable material. This label indicates the medical supply maker and identifies the medical supply as being RF detectable.

Alternatively, the RF detectable material may also be woven into the medical supply as a line going through it, or in a manner that is readily identifiable by scanning. For example, the RF detectable material can be similar to a thread and stitched or woven into the medical supply.

Some medical supplies are disposable but others are re-usable. The medical supplies can be sterilized, for example by Gamma radiation or steam, or used unsterilized. Furthermore, the medical supplies can be colorized to indicate whether they are disposable, re-usable, sterilized, or unsterilized.

Rather than enclosing the RF detectable material in the hem, the material can be sewn, woven into or adhered to the medical supply.

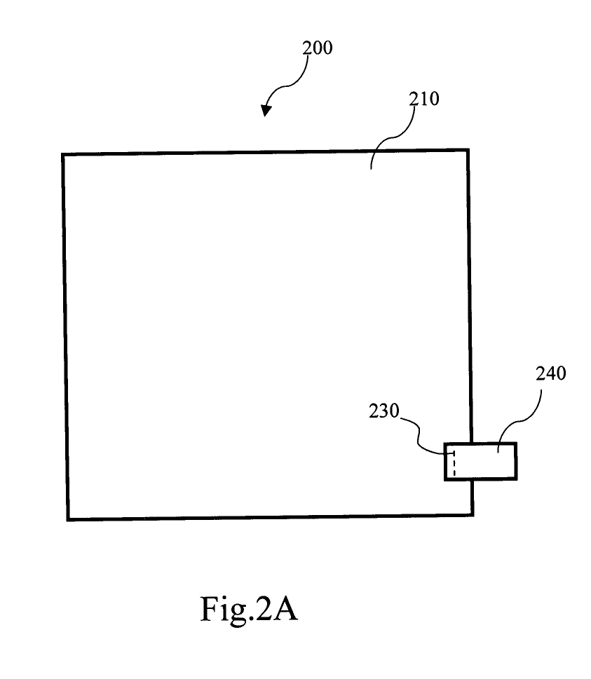

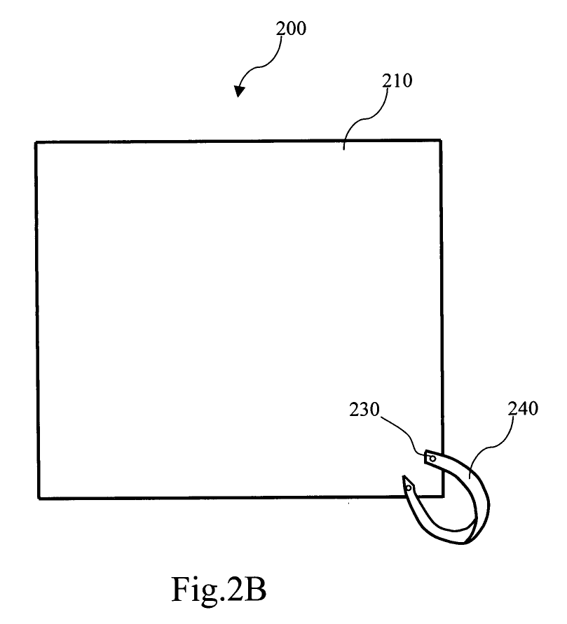

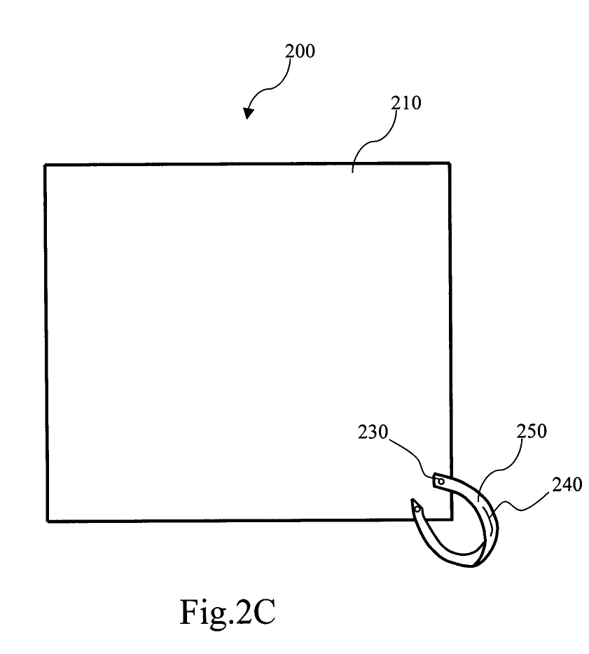

Refer to FIG. 2A, which is a drawing illustrating a medical supply with radio frequency detectable material according to an embodiment of the present invention.

Certain medical supplies are not hemmed as those illustrated in FIGS. 1A-D. As shown in FIG. 2A, the RF detectable medical supply 200 of the present invention comprises an unhemmed medical supply 210 and an RF detectable material 240 connected to the medical supply 210 by an attaching means 230. For example, the RF detectable material 240 can be stitched by thread to the medical supply 240. However, any other connecting means such as adhesive, bonding, or weaving can be used. Additionally, the RF detectable material 240 can comprise a label or be enclosed in a label or tag. This allows the medical supply to be easily grasped by hospital personnel.

Refer to FIG. 2B, which is a drawing illustrating a medical supply with radio frequency detectable material according to an embodiment of the present invention.

In this embodiment of the present invention the RF detectable material 240 is attached to the medical supply 210 by the connecting means 230 in the shape of a loop. This allows the medical supply 210 to be easily grasped or hung.

Refer to FIG. 2C, which is a drawing illustrating a medical supply with radio frequency detectable material according to an embodiment of the present invention.

As shown in FIG. 2C, the RF detectable material 240 is attached to, encased in, woven in, or adhered to, a loop 250 attached to the medical supply 210. The loop 250 is attached to the medical supply 210 by connecting means 230.

In use, the RF detectable material can be programmed at the manufacturing facility. Prior to surgery medical personnel can easily scan the RF detectable medical supplies to take an inventory of the items that will be used during the operation. Since the RF detectable material can also comprise unique identifiers, the individual codes can be noted.

Alternatively, the RF detectable material can be programmed at the hospital or medical facility. This is a simple procedure and has the benefit of adding more flexibility in the type or kind of code or data in the identifier. For example, a specific date, surgeon, hospital, or patient could be identified by the code. Furthermore, in cases where the medical supply can be sanitized and re-used, the code could be re-written if appropriate.

After surgery or prior to closure of the incision in the patient, medical personnel can quickly take an inventory to ensure that all medical supplies are accounted for. If any are missing, a quick scan of the patient using a scanner or transceiver can locate the missing medical supplies. In this way, no medical supplies will be inadvertently left inside the patient.

As described above, the present invention provides a medical supply with RF detectable material which eliminates the need for re-entry into a patient after operating in situations where medical supplies are missing.

Utilizing the towel of the present invention, the patient can easily be scanned to determine whether a medical supply has been left inside the patient after surgery. Upon scanning, the RF detectable material can easily be observed by medical personnel if a towel is still inside the patient. If no RF detectable material is observed, unnecessary re-entry into the patient is prevented thereby reducing a patient's suffering and the risk of malpractice lawsuits. Additionally, utilizing RF detectable material instead of other detectable materials prevents unnecessary exposure to chemicals or radiation such as x-ray radiation. This further enhances the safety of the RF detectable medical supply of the present invention.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A radio frequency detectable medical supply comprising;
a piece of medical supply; and
at least one piece of radio frequency detectable material connected to the medical supply, the radio frequency detectable material allowing indication of the medical supply upon scanning.

2. The radio frequency detectable medical supply of claim 1, the medical supply comprising an operating room towel, a laparotomy sponge, a pad, gauze, cotton, swab, or bandage.

3. The radio frequency detectable medical supply of claim 1, the radio frequency detectable material comprising a radio frequency tag or a radio frequency identification tag.

4. The radio frequency detectable medical supply of claim 1, wherein the radio frequency detectable material is connected to the medical supply by stitching.

5. The radio frequency detectable medical supply of claim 1, wherein the radio frequency detectable material is incorporated into a tag, stitched to the medical supply, sewn into a seam of the medical supply, incorporated in a handle of the medical supply, woven into the medical supply, or is the handle of the medical supply.

6. The radio frequency detectable medical supply of claim 4, whereby the stitching uses a thread of a different color than a color of the medical supply.

7. The radio frequency detectable medical supply of claim 1, the medical supply comprising cotton, synthetic material, gauze, foam, sponge, or a combination of these.

8. The radio frequency detectable medical supply of claim 1, the radio frequency detectable material comprising shaped, coded, data, numbered, or identifying characteristics to identify a scanned object as a medical supply.

9. The radio frequency detectable medical supply of claim 1 further comprising:
an identifier on the medical supply that indicates the medical supply is a radio frequency detectable medical supply.

10. The radio frequency detectable medical supply of claim 9, the identifier comprising a label, thread, tag, marking, printing, number, letter, shape, code, or color.

11. The radio frequency detectable medical supply of claim 9, wherein the identifier is visible.

12. A radio frequency detectable medical supply comprising;
a piece of medical supply;
at least one piece of radio frequency detectable material connected to the medical supply, the radio frequency detectable material allowing indication of the medical supply upon scanning; and
an identifier on the medical supply that indicates the medical supply is a radio frequency detectable medical supply.

13. The radio frequency detectable medical supply of claim 12, the medical supply comprising an operating room towel, a laparotomy sponge, a pad, gauze, cotton, swab, or bandage.

14. The radio frequency detectable medical supply of claim 12, the radio frequency detectable material comprising a radio frequency tag or a radio frequency identification tag.

15. The radio frequency detectable medical supply of claim 12, wherein the radio frequency detectable material is connected to the medical supply by stitching or weaving.

16. The radio frequency detectable medical supply of claim 12, wherein the radio frequency detectable material is incorporated into a tag, stitched to the medical supply, sewn into a seam of the medical supply, woven into the medical supply, incorporated in a handle of the medical supply, or is the handle of the medical supply.

17. The radio frequency detectable medical supply of claim 15, whereby the stitching uses a thread of a different color than a color of the medical supply.

18. The radio frequency detectable medical supply of claim 12, the medical supply comprising cotton, synthetic material, gauze, foam, sponge, or a combination of these.

19. The radio frequency detectable medical supply of claim 12, the radio frequency detectable material comprising shaped, coded, data, numbered, or identifying characteristics to identify a scanned object as a medical supply.

20. The radio frequency detectable medical supply of claim 12, the identifier comprising a label, thread, tag, marking, printing, number, letter, shape, code, or color.

21. The radio frequency detectable medical supply of claim 12, wherein the identifier is visible.
